(19) United States
(12) Patent Application Publication
(10) Pub. No.: US 2002/0169773 A1
(43) Pub. Date: Nov. 14, 2002

(54) Broadcast art show

(76) Inventors: Bruce Hogue Penrod, Denver, CO (US); Mark A. Bogani, Greenwood Village, CO (US)

Correspondence Address: Ruth Eure, 4795 Edison Avenue, Boulder, CO, 80301, US

(21) Appl. No.: 09/855,867

(22) Filed: May 14, 2001

(51) Int. Cl. G06F 7/00

(52) U.S. Cl. 707/6

(57) ABSTRACT

The invention disclosed consists of a process that consists of the steps capturing and collecting digital images of original art works, sorting those images into working sets or groupings, distributing and displaying the digital imagery of the sets or groups in a number of commercial venues and private residences via a slide show utilizing high-resolution video media including television sets and projection onto walls or screens. This process will serve to 1) expose artists' works to a broad audience widely distributed throughout a broad geographic area, 2) entertain its audience; and 3) introduce that audience to dazzling new ‘high-definition’ displays, generally defined as having XGA resolution or higher.

### FIELD OF INVENTION

This invention relates to the art of digital imagery, and more specifically to digital imagery utilized for the display of art works in a number of commercial venues and private residences via a slide and video show utilizing high-resolution video media including television sets and projection onto walls or screens therefor.

### BACKGROUND

Description of the Prior Art

Currently, means of exhibiting visual works of art consist of a) physical display, such as display in an art gallery, art show, at an individual's home or in an office; and b) electronic/print display, such as Internet art gallery sites with small images for review, screen savers of various kinds and art publications/books. These methods work in narrow, specific applications, such as locating works of a known artist but do not serve to broadly expose new artists. Artists must find venues to display their art so that it is seen, accepted and purchased by the public. This may involve local art shows, which may have limited public appeal and limited marketing utility.

A rotating display of art images is also known, such as that accomplished by a commercial screen saver published by Microsoft (e.g., Microsoft Scenes). But this screen saver is not adapted to jointly exhibit both the art and the artist. Like many others, it only exhibits works of art seriatim, and does not provide specific presentation of artists in an educational manner. In addition, the ‘inventory’ of prior screen savers is limited to relatively few pictures and when observed over a long period, these transition effects become anticipatory and somewhat monotonous. Such a system does not facilitate learning by association of artists' likenesses and/or backgrounds and their respective works within a presentation group, nor serve to present the artists' works to potential buyers.

Currently, enjoyment of artwork requires initiative. People must actively go out and seek artwork at an art show, art gallery or museum. These are not passive activities where a person could sit and enjoy the artwork at their leisure. There exists a need for a show allowing passive enjoyment.

There are commercial venues where there is a need for some type of silent, non-intrusive entertainment. These are venues like restaurants, stores or a quiet bar, in which any entertainment must not conflict with normal conversation. This type of entertainment need is not currently being met.

In just the last few years the digital world has exploded with impressive new products and services. Among these are high definition television technology, also used in computer monitors and large-scale commercial video displays, in which far more pixels are used to present an image. This new technology has unexplored uses and opportunities. It has been used in malls and other such forums for entertainment and advertising.

A need exists for silent, passive entertainment, and a better method for artists and promoters to display and market their work.

### SUMMARY OF THE INVENTION

One object of the present invention is to provide entertainment, which gives value to venues, patrons and advertisers.

An additional object of the present invention is to provide an inexpensive and efficient method for artists and promoters to display and sell their artwork to a broad, far-flung audience.

A further object of the invention is to provide an opportunity to expose the public to high definition television/display technology.

The process of the present invention consists of capturing and collecting digital images of original art works, sorting these images into working sets or groupings, distributing and displaying the digital imagery in a number of commercial venues and private residences via a slide and video show utilizing high-resolution video media including television sets and projection onto walls or screens.

The process will serve to 1) expose artists' works to a broad audience, 2) entertain the audience; and 3) introduce that audience to dazzling new ‘high-definition’ displays or digital televisions, generally defined as having XGA resolution or higher.

This process benefits all parties. 1) Artists gain exposure and sales of originals and reproductions from remote locations; where heretofore their work was only available at a physical gallery or upon an Internet search conducted by a potential patron—an unlikely thing. 2) Venues benefit from providing entertainment to patrons, helping to attract and keep more patrons (i.e. bars are able to sell more drinks, restaurants are able to sell more food, stores to sell more items). 3) Television and projector manufacturers can now expose their impressive new ‘high-definition’ displays to a broad, general audience which are candidates to go out and purchase these new-generation televisions for their homes. 4) The public is exposed to enjoyable art without the requirement to seek out galleries and museums and take the time to go see the art (i.e. their role is passive). The show will solicit advertising and charge fees to artists, their promoters, and some venues.

One of the technological innovations of recent times is digital imagery, in which pictures are recorded digitally. One advantage is that such images can be transmitted and reproduced without any loss of picture quality, since the file is either received in full or not at all. Since this process expects to receive digital art files from numerous remote locations (where artists live and work) and sort and combine them for distribution to numerous remote locations (public venues around the U.S. and elsewhere), the ability to transmit files over the Internet is quite important.

The process will utilize the Internet in several ways. Artists will arrange to photograph or scan their works of art (or other type of digital image, such as landscapes) in jpeg format. These images will be ‘uploaded’ to a web site (the “Collection Web Site”) administered for the purpose of receiving artwork, securing legal releases from the artist, collecting fees and explaining to artists the rules governing the system.

A second web site (the “Public Web Site”), will be for the public to inquire about 1) home service and 2) individual art pieces they may have seen in a public display (identified by serial number displayed alongside the piece). An inquiry about a particular artwork will yield the artist's personal information, information about the piece, sale prices of original and/or reproductions, and contact information both for the artist and the Broadcast Art Show.

In addition to the above, the process will utilize a wide area network (‘WAN’) over the Internet to move digital art files and advertising files to the numerous remote (‘satellite’) sites at the display venues and receive reports back on operating data. The ‘satellite’ site will be connected to the Internet via conventional hard wire, radio, or satellite direct broadband.

The process is more efficient, effective, accurate and functional than the current art.

### BRIEF DESCRIPTION OF THE DRAWINGS

Without restricting the fill scope of this invention, the preferred form of this invention is illustrated in the following drawings:

FIG. 1 shows an overview of the system, and

FIG. 2 shows the flow of the digital image from collection to display, and

FIG. 3 shows the flow of the digital image to and from the collection web site, and

FIG. 4 shows one possible end use variation from the collection web site.

### DESCRIPTION OF THE PREFERRED EMBODIMENT

The preferred embodiment of the invention is a process consisting of soliciting and collecting digital images of original art works, sorting those images into working sets or groupings, distributing and displaying the digital imagery in a number of commercial venues and private residences via a slide and video show utilizing high-resolution video media including television sets and projection onto walls or screens.

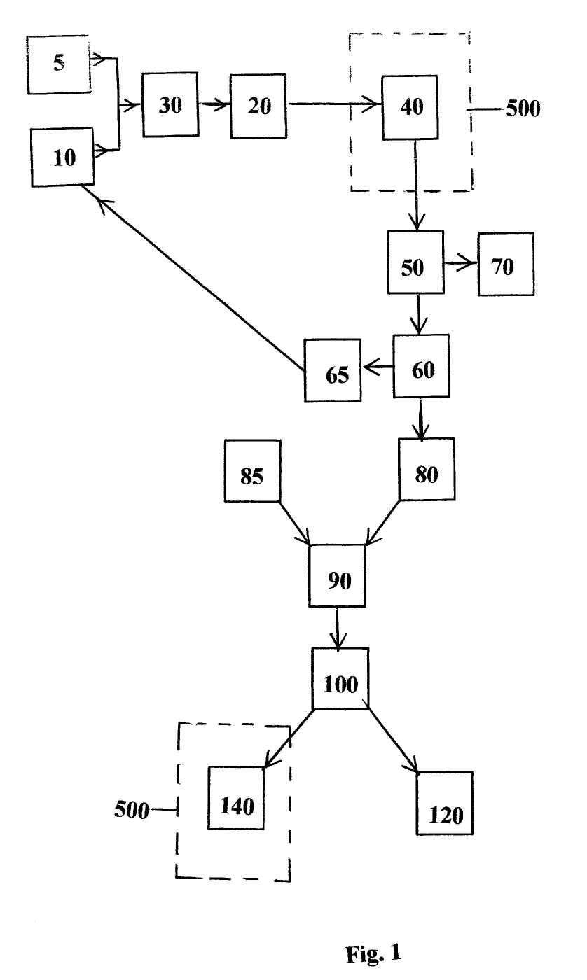

Referring initially to FIG. 1, the major steps of the process are set forth. The artists 5 and promoters 10, such as Gallery owners, capture 30 the artwork via digital imagery, creating a digital image 20, which artwork can be paintings, prints, artistic photographs, computer generated art, sketches or any other type of artwork, and upload to the system 1. The system collects the captured images 20 of the artwork by maintaining a Collection website 40 for receiving such images 20 from artists 5 and promoters 10. A digital image can be achieved by digital photography, digital scanning, or generating a digital file on computer, which file is then transmitted to the system 1 via the Internet 500. The images 20 are captured 30 in a standard format such as jpeg, which is well known in the art. The system 1 then prompts a human review 50 of the images 20 to decide to accept 60 or reject 70 the submitted images 20. Rejected images are discarded; accepted images are placed in queue for file review 80. Images 20 which are accepted 60 for display generate an invoice to the submitting party, and a charge 65 will be issued to the artists 5 or promoters 10. Once accepted, image files 20 are reviewed 80 for technical correctness, including format and size. At this point each digital image 20 is issued an identifying code to reflect artist and type of art. These codes can be used to construct groupings 100 which include the desired mix of art type and authorship.

The accepted images 20 are compiled 90 into groups or groupings 100 for presentations. Broadcast Art Show may solicit advertising 85 from a variety of sources. Such advertising may be stills (jpeg) or video (mpeg). This advertising will be inserted into the groups 100 as appropriate. These groups 100 are then transmitted to distant locations or remote venues 120. These groups 100 are displayed in remote locations 120 using any one of a number of standard display devices. In the preferred embodiment, displays to be used in the system will be front projection (onto a wall or a screen mounted on a wall). It is also possible the system will utilize rear projection ‘big screen’ televisions in certain locales and even CRT (cathode ray tube) and plasma-based monitors in a few instances. In the preferred embodiment, all of the image 20 files will be jpeg for stills, mpeg for videos. The groupings 100 are a collection of individual jpegs and mpegs. In addition, groupings 100 are stored into the public website 140 where the art show will be made available over the Internet 500 just as it is offered in the many remote locations 120.

The process is designed to capture, collect, sort, distribute and display digital imagery, primarily images of original art works, in a number of commercial venues and private residences via a slide and video show utilizing high-resolution video media including, but not limited to, television sets and projection onto walls or screens. The system 1 serves to 1) expose artists' works to a broad audience; 2) entertain its audience; and 3) introduce that audience to dazzling new ‘high-definition’ displays, generally defined as having XGA resolution or higher, which is far better than the conventional analog television signal currently the norm.

One of the technological innovations of recent times is digital imagery. Digital imagery is well known in the art with some of the more common methods being digital photography and scanning. One advantage is that such images can be transmitted and reproduced without any loss of picture quality, since the image is either received in full or not at all. Since the system is intended to receive art digital files from numerous remote locations, such as where the promoter and artist live and work, and sort and combine them for distribution to numerous remote locations and public venues, the ability to transmit digital files over the Internet is quite important.

The system 1 will utilize the Internet 500 in several ways. Artists 5 and promoters 10 will digitally image (scan, photograph, or computer generate) their works of art in jpeg format producing an image 20 picture. These images 20 will be ‘uploaded’ to the collection web site 40 administered by the system 1 for the purpose of receiving art work, securing legal releases from the artist, collecting fees, and explaining to artists the rules governing the system 1. Access to the collection web site 40 can be accomplished directly through a local Internet service provider, often referred to as ISP's or through an on-line service provider. The artists 5 and promoters 10 contact the collection web site 40 using an informational processing system capable of running an HTML-compliant web browser such as Microsoft's Internet Explorer, Netscape Navigator, Lynx and Mosaic, for example. A typical personal computer with an operating system running a web browser can be used. Those skilled in the art may conclude that any HTML (Hyper Text Markup Language)-compatible web browser is within the true spirit of this invention and scope of the claims.

The collection web site 40 uses a typical web page in HTML format. The method begins with the display of the collection web site 40. The artists 5 and the promoters 10 connect to the collection web site 40 using a compatible web browser to access Internet 500 as disclosed above. The collection web site 40 will have numerous data entry fields. The first time that artists 5 use the web site 40 they will be prompted for information regarding themselves and the artwork 20 that they plan to submit. The artists 5 must register on the collection web site 40 in order to get an artist's registration number. This artist's registration number is used to identify the artist. Registration may include some or all of the following data: name, address, and social security number, biography, a digital picture of the of artist 5 or the artist's 5 studio or both, the artist's 5 contact information, a self-descriptive narrative from the artist describing his/her art, theories, any awards or shows of note, and anything else he/she wants the public to see upon inquiry. An encrypted field can be included which includes the artist's billing information. In the preferred embodiment the artists 5 and promoters 10 may pay a fee to have works exhibited. When first registering there is no charge—only after a submitted work is accepted for display. The billing information can be the standard information needed such as credit card number, expiration date, billing address, etc. The artists 5 may input their e-mail address. There may also be an affirmative copyright permission button that gives permission to display the artwork. After all of the required fields are completed, the artist 5 or promoter 10 will be prompted to upload the digital image 20 of the artwork 20.

Upon registration, the system 1 will create and assign each artist 5 a unique folder on the collection site 40 that will receive their uploaded digital image files 20. When a digital image file 20 is uploaded it will include the title, date, and any narrative about the artwork uploaded and whether the original or any reproductions are for sale and the price.

In the preferred embodiment, to help promote the use of the system 1, the system 1 will permit artists 5 and promoters 10 to submit artworks for contests in which prizes are to be awarded to the artists 5 based on their artwork 20. This will increase the volume of artists 5 who use the system 1 increasing the number of artworks 20 that can be displayed. The collection web site 40 will have a web page that contains a list of current contests and prizes available. The collection web site 40 may have an Overview section explaining the system 1 to the artist 5. The collection web site 40 may have a FAQ (frequently Asked Questions) section. The collection web site 40 in the preferred embodiment gives the prices charged to the artist 5 for the services. Access to the collection web site 40 can be accomplished directly through a local Internet Service Provider, often referred to as ISP's or through an on-line service provider.

Upon upload, the digital image 20 will be collected 40 by the system 1 and placed in queue for human review 50 for acceptance 60 into the show or rejection 70. If accepted, the artist or promoter will be charged 65 the agreed upon fee for display. Once accepted, the digital file is submitted to a technical file check or file review 80 to make sure the image 20 is in a proper format, not corrupted and is the proper file size. After the file check 80 is completed, the image 20 is assigned a unique serial number 82. The artist's name and the serial number may be digitally added to the border of the image 25 during the recompiling process 84.

Referring again to FIG. 1, at this point, the digital images 20 are compiled 90. The compiled art 90 comprises the groupings 100. In one preferred embodiment, these groupings 100 are based on consecutive serial numbers. This allows for a large variety in the types of artwork in a grouping. Alternatively, the groupings 100 could be based on styles or types of art works or an individual artist 5. In one embodiment, the groupings 100 are interspersed between advertising video sequences 85 in which the artwork images 20 are shown in sequence for a select period of time. The advertising video sequences 85 are comprised of both still segments and video segments. The period of time that the still images are shown will be approximately one to three minutes in the preferred embodiment.

There is an industry move to digital imagery since, under old analog systems, outlying areas could receive ‘ghost’ transmissions with considerable interference. Digital signals, on the other hand, are either perfect or they don't arrive at the set, so the reproduction is either identical to the source or non-existent. The system will make good use of this digital, higher definition format in jpeg still images and mpeg videos. While in the preferred embodiment all displays to be used in the system will accept digital signals, and the company intends to use primarily front projectors (onto a wall or a screen mounted on a wall) such as a Toshiba TLP 670, for example, it is possible the show will utilize rear projection ‘big screen’ televisions in certain locales and even CRT (cathode ray tube) and Plasma-based monitors (“displays”) in a few instances. With all these systems, the ability to display digital signal sources will make the appliance suitable for the new digital television broadcasts as they appear.

In the preferred embodiment the system 1 will use software to complete the complicated requirements of the Art Show. The operating system will likely be Windows 2000 Server and the software can be written in a standard programming language such as C, for example, and interact with both collection web site 40 and public web site 140 using standard programming languages, formats and processes that are already known in the art.

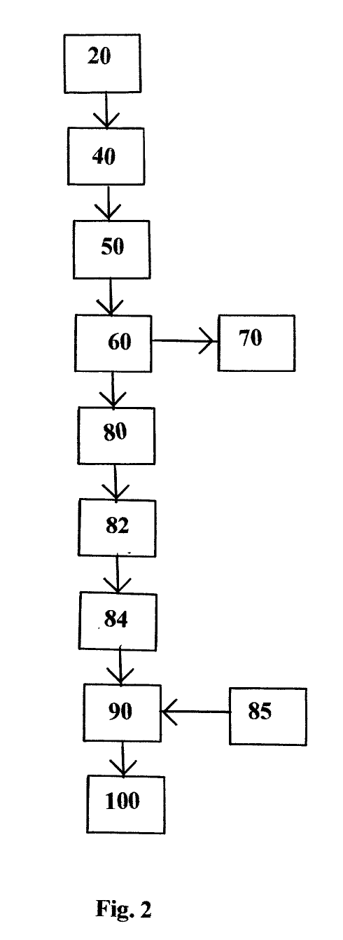

FIG. 2 shows a data flow of the software having the following steps: the collection web site 40, accepts 60 and compartmentalizes newly ‘uploaded’ digital files submitted by artists, it o places the submission in a review process for acceptance into the ‘show’ or grouping 100, if accepted it checks 80 the file size and flags the digital image 20 for digital re-mastering, it assigns each file a serial number 82 based on artist, medium and type of art, it re-compiles 84 digital art work images 20 into discreet ‘shows’ or groupings 100 along with advertising segments 85. Groupings 100 are comprised of stills and advertising videos 85. Each assigned serial number will consist of a series of unique numbers or letters.

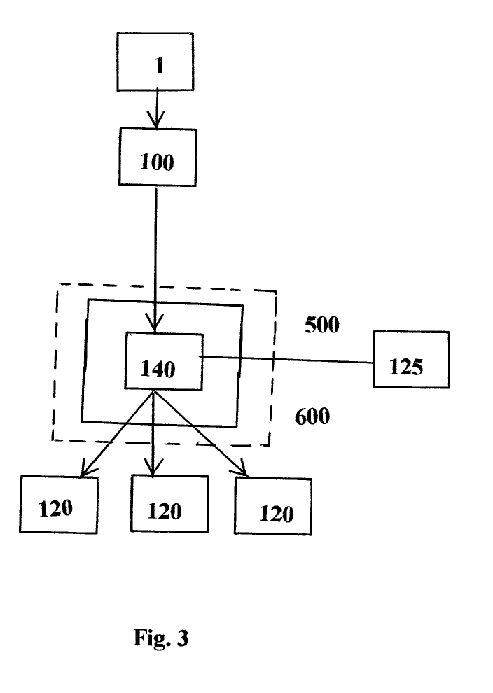

Referring to FIG. 3, in addition to the above, the system 1 may utilize a wide area network (‘WAN’) 600 to move the groupings 100 of the digital art images 20 and advertising video sequences 85 to the numerous remote (‘satellite’) sites 120. The public will have access to the public web site 140 via Internet 500 using conventional hard wire, radio, or satellite direct broadband or any other type of Internet connection means. In alternative, the groupings 100 can be loaded to a computer hard drive or written to a CD-ROM (compact disc) or DVD (digital video disc) for subsequent distribution to remote sites 120.

Again referring to FIG. 3, the software will run the show at the remote (satellite) locations 120. The satellite software will dictate pace, selection, advertising inserts, accept and store updates, and report on usage. In the preferred embodiment, the hardware at the satellite site 120 will include a PC (personal computer) with operating system, large storage media (hard drives/cd roms/dvdiscs) and software to produce the show, interspersing artistic videos and slides, advertising stills and advertising videos into the flow of the of the art show. Advertising images will be injected between the displays of art images 20. The advertisers will either be based at the venue where the groupings will be shown or be major brand advertisers. In the preferred embodiment, these advertising images are stored and retrieved from a large storage media on the hardware at the satellite site 120.

As shown in FIG. 3, a second web site, the public web site 140, which is completely removed from the first collection web site 40, will be for the public 125 to inquire about 1) home service and 2) individual art pieces they may have seen in a public display. These works are identified by serial number displayed alongside the piece on the image 20. Inquiries related to this serial number yield artist's information, information about the piece, sale prices of original and/or reproductions and artist contact information.

The system 1 will administer the public web site 140 to handle inquiries on pieces, the show, home version, etc. The system is designed to allow artists 5 to sell originals or reproductions of their art works directly to buyers generated by the system.

The public may contact the public web site 140 using an informational processing system capable of running an HTML-compliant Web browser such as Microsoft's Internet Explorer, Netscape Navigator, Lynx and Mosaic, for example. The public could use a personal computer with an operating system running a web browser. The exact hardware configuration of computer used by the public, the brand of operating system or the brand of Web browser configuration is not critical to the operation of the present invention.

The public web site 140, shown in FIGS. 1, and 3, will have the following functionality. It will have access to a database that stores all art works by serial number, type of art and artist's name, permitting inquiry about work, price, artist, and possible digital file acquisition. This database will be in an industry standard format such as SQL. The public web site 140 may allow inquires to the database. The public web site 140 may have an option for the public 125 to view a slide show similar or identical to that on public display from a computer terminal. The public web site 140 may have a link to a web page that offers information to prospective public venues interested in offering the show and information to prospective homeowners interested in the home version (without advertising) of the show, for which a fee will be charged. The public web site 140 may have a web page that will offer an overview of the system to any interested parties (artists, venue owners, potential advertisers and consumers) and may give contact information to a home office. The public web site 140 may also have biographical and self-description information about individual artists.

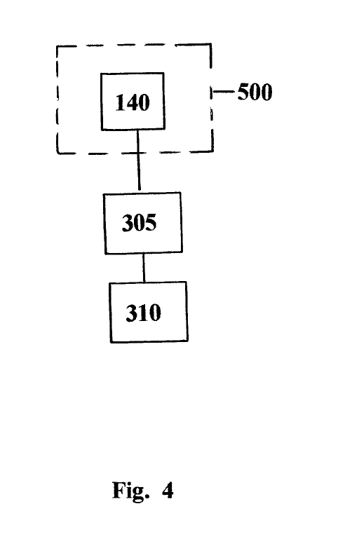

As shown in FIG. 4, the process is designed to achieve sales of digital files of specific art works for a modest price to users 310 wanting a ‘library’ 305 of favored art works for display at home. Images displayed on the public web site 140 can be ‘watermarked’ or otherwise protected from download, hopefully encouraging buyers to pay for individual pictures. This watermarking will be done using standard secure processes that are well known in the art. The public web site 140 will include purchase information and a shopping cart interface allowing patrons to purchase individual pieces for their personal libraries. Such shopping cart web pages are well known in the art and are not covered here. In the preferred embodiment, there are three categories of art to be shown: 1-images of paintings, 2-computer generated art and 3-natural photography, such as pictures of scenes in National Parks, for example.

### ALTERNATIVE EMBODIMENTS

In an alternative embodiment, the system could be used to capture, collect, group and distribute digital video files from video artists and promoters. Any digital video format could be used but in the preferred embodiment, the jpeg and mpeg formats will be used.

### ADVANTAGES

The previously described version of the present invention has many advantages. The intent is to develop a process that allows a broader audience to view and appreciate the artwork in a method that is easier, less expensive, less labor intensive and more efficient. The process benefits all parties. Artists gain exposure and sales of originals and reproductions from remote locations, where heretofore their work was only available at a physical gallery or upon an Internet search conducted by a potential patron (an unlikely thing). Venues benefit from providing entertainment to patrons, helping to attract and keep more patrons (i.e. bars able to sell more drinks). They can offer silent entertainment that adds to the atmosphere of the venue. Television and projector manufacturers expose their impressive new ‘high-definition’ displays to a broad, general audience, which are candidates to go out and purchase these new-generation displays for their homes. The public is exposed to enjoyable art without the need to seek out galleries and museums and take the time to go see the art (their role is passive).

Although the present invention has been described in considerable detail with reference to certain preferred versions thereof, other versions are possible. For example, the file could use a different format or a new protocol to communicate with the system or different types of artwork may be communicated or it could be used in an Intranet environment. Therefore, the point and scope of the appended claims should not be limited to the description of the preferred versions contained herein.

That which is claimed:

1. A process comprising the steps of:
a) using a capturing means to capture the image of artwork,
b) using a collecting means to collect the images of the artwork,
c) using a grouping means to sort those images into a grouping,
d) using a distribution means to distribute the grouping, and
e) using a displaying means to display the grouping containing the images of the artwork.

2. A process comprising the steps of:
a) creating one or more digital image files of artwork,
b) transmitting the digital image file,
c) collecting the digital image file,
d) accepting or rejecting the digital image file,
e) compiling the accepted digital image files to form a grouping,
f) transmitting the grouping of digital image files, and
g) displaying the grouping.

3. The process of claim 2, further including combining advertising files with the accepted digital image files into the grouping.

4. The process according to claim 2 wherein the digital image files are jpeg and mpeg files.

5. The process according to claim 2 wherein the artist takes a digital photo or scans a picture to create the digital image file.

6. The process according to claim 2 wherein the grouping is transmitted over Internet.

7. The process according to claim 2 wherein the grouping is transmitted by making a cd-rom or dvd of the grouping and physically transferring the cd-rom or dvd.

8. The process according to claim 2 wherein the grouping is transmitted over Internet to remote locations.

9. The process according to claim 2 wherein the digital image is transmitted to a collection web site.

10. The process according to claim 2 wherein the grouping is displayed on a public web site.

11. The process according to claim 2 wherein the grouping is displayed by projection onto a wall or screen.

12. The process according to claim 2 wherein the grouping is displayed on a personal computer.

13. The process according to claim 2 wherein the grouping comprises a combination of jpeg and mpeg digital image files.
